(19) United States
(12) Patent Application Publication
(10) Pub. No.: US 2025/0170588 A1
(43) Pub. Date: May 29, 2025

(54) HIGH-GRAVITY DEVICE AND ENERGY-OPTIMIZED HIGH-GRAVITY DECARBONIZATION SYSTEM

(71) Applicant: CHINA UNIVERSITY OF PETROLEUM (EAST CHINA), Qingdao (CN)

(72) Inventors: Jianlu ZHU, Qingdao (CN); Yuxing LI, Qingdao (CN); Nan LI, Qingdao (CN); Qihui HU, Qingdao (CN); Wuchang WANG, Qingdao (CN); Hui HAN, Qingdao (CN)

(21) Appl. No.: 18/889,750

(22) Filed: Sep. 19, 2024

Related U.S. Application Data
(63) Continuation of application No. PCT/CN2024/072785, filed on Jan. 17, 2024.

(30) Foreign Application Priority Data
Nov. 29, 2023 (CN) 202311613779.X

(51) Int. Cl. B04B 5/04; B04B 15/02

(52) U.S. Cl. CPC B04B 5/0442; B04B 15/02

(57) ABSTRACT

The present invention provides a high-gravity device and an energy-optimized high-gravity decarbonization system, the high-gravity device comprises a housing, having a cavity therein; a solution inlet, a solution outlet, a gas inlet, and a gas outlet are provided on the housing; a rotating shaft, a packing, a packing lower clamping plate, and a packing upper clamping plate are provided in the cavity; wherein, the packing arranged between the two clamping plates is trapezoidal in section and is symmetrically placed on both sides of the rotating shaft; the packing upper clamping plate has a certain inclination angle, and an annular bulge is provided on the packing lower clamping plate; one end of the rotating shaft is arranged in the cavity, and another end extends out of the housing and is further connected to a driving mechanism; and, spray pipes are provided on both sides of the rotating shaft and are connected to the solution inlet.

The present invention claims priority benefits to Chinese Patent Application number 202311613779.X, entitled “high-gravity device and energy-optimized high-gravity decarbonization system”, filed on Nov. 29, 2023, with the China National Intellectual Property Administration (CNIPA), the entire contents of which are incorporated herein by reference.

### TECHNICAL FIELD

The invention belongs to the field of gas-solution mass transfer equipment, and particularly relates to a high-gravity device and an energy-optimized high-gravity decarbonization system.

### BACKGROUND

The statements in this section merely provide background information related to the present invention and do not necessarily constitute prior art.

The high-gravity reactor (HGR) is a new type of industrial reactor, using the strong centrifugal force (or high-gravity) produced by the packed bed rotating at high speed to make the solution disperse and break up to form a larger and newer surface, and the gas-solution contact fully to obtain better heat and mass transfer effect.

The residence time of solution in the rotating packed bed in HGR is generally short (<1s), but when higher mass transfer effect is required, it is generally necessary to increase the residence time of gas and solution by increasing the thickness of packing. Considering the mechanical stability of rotation of the high-gravity rotating bed, the rotating packed bed is usually placed with vertical rotating axis. Under the influence of gravity, the closer to the outer edge of the rotating shaft, the closer the solution distribution is to the lower side of the packing, which will lead to the majority of solution passing through the lower side of the packing and the gas passing through the upper side of the packing with less solution in the process of gas-solution countercurrent mass transfer. Gas-solution distribution is not uniform, thus reducing the mass transfer effect.

### SUMMARY

In order to solve the technical problems existing in the above background art, the present invention provides a high-gravity device and an energy-optimized high-gravity decarbonization system, wherein the high-gravity device can improve the uniformity of gas-solution distribution in the upper half of packing, reduce the area of ineffective gas-solution contact, and improve the utilization rate of solution, so that gas-solution contact is fully made.

To achieve the above object, the present invention adopts the following technical solution.

A first aspect of the invention provides a high-gravity device.

The high-gravity device, comprising:
a housing, having a cavity therein, wherein a rotating shaft, a packing, a packing lower clamping plate and a packing upper clamping plate are provided in the cavity; a solution inlet, a solution outlet, a gas inlet and a gas outlet are provided on the housing; wherein
the packing upper clamping plate is provided with a certain inclination angle, the packing arranged between the packing upper clamping plate and the packing lower clamping plate is trapezoidal in section; an annular bulge is provided on the packing lower clamping plate;
one end of the rotating shaft is arranged in the cavity, and another end of the rotating shaft extends out of the housing and is connected with a driving mechanism; and
the packing is symmetrically arranged on both sides of the rotating shaft, spray pipes are provided on the both sides of the rotating shaft, and the spray pipes are connected with the solution inlet.

As an implementation mode, a static disk is symmetrically arranged on an inner wall of the housing, a movable disk is symmetrically arranged on the rotating shaft, the movable disk is arranged under the static disk, solution on the inner wall of the housing flows into an inner ring of the movable disk through an upper surface of the static disk under an action of gravity, then is thrown out from an outer ring of the movable disk under an action of centrifugal force, and then is finally led out from the solution outlet.

As an implementation mode, a length of a short base of the trapezoid of the packing (i.e. an axial height of the packing) is obtained by deducing and calculating an average residence time of the solution.

As an implementation mode, the average residence time of the solution is derived from a solution holdup rate.

As an implementation mode, the solution inlet is used for introducing solution and spraying the solution on an inner side surface of the packing through a spray pipe; and the solution outlet is used for leading out the solution thrown to the inner wall of the housing by the rotating shaft under the action of gravity.

As an implementation mode, the gas inlet is used for introducing gas to be purified, the gas to be purified enters the packing from an outer edge of the rotating shaft under an action of gas pressure, and contacts with the solution in countercurrent and transfers mass and heat, then a purified gas leaves the rotating shaft from a center of the rotating shaft and is finally led out from the gas outlet.

As an implementation mode, a portion of the rotating shaft extending out of the housing is connected to the housing by a bearing seal.

A second aspect of the invention provides an energy-optimized high-gravity decarbonization system.

The energy-optimized high-gravity decarbonization system, comprising:
a first high-gravity device, a rich amine solution tank, a lean/rich solution heat exchanger, a steam-rich solution heat exchanger, a steam-cooling water heat exchanger, a lean amine solution-cooling water heat exchanger, a tubular falling-film reboiler, a gas-solution separator, a second high-gravity device, a lean amine solution tank, and a CO₂-water separator; wherein the first high-gravity device and the second high-gravity device both are the high-gravity device described in the first aspect; wherein
the first high-gravity device is connected to an uppermost end of an outer wall of the rich amine solution tank;
a rich amine solution is outputted from a bottom of the rich amine solution tank and is delivered to the lean/rich solution heat exchanger;
a rich solution outlet of the lean/rich solution heat exchanger is connected to a rich solution inlet of the steam-rich solution heat exchanger, and a rich solution outlet of the steam-rich solution heat exchanger is connected to a solution inlet of the tubular falling-film reboiler;
a molecular sieve regeneration solid catalyst is added on a path through which a solution in the tubular falling-film reboiler flows; a material outlet of the tubular falling-film reboiler is connected to the gas-solution separator, a solution in the gas-solution separator is delivered to a solution inlet of the second high-gravity device, and a steam in the gas-solution separator is introduced into a gas inlet of the second high-gravity device;
a mixed gas of CO₂ and steam is delivered from a gas outlet of the second high-gravity device into the steam-rich solution heat exchanger, and then is led into the steam-cooling water heat exchanger after heat exchange; and
a condensed water output from a bottom of the CO₂-water separator is delivered to the lean amine solution tank, a solution outlet of the second high-gravity device is connected to the lean amine solution tank, a lean solution collected in the lean amine solution tank from the second high-gravity device is delivered to the lean/rich solution heat exchanger for heat exchange, further is cooled via the lean amine solution-cooling water heat exchanger, and finally is delivered to the first high-gravity device as an absorption solution.

As an implementation mode, the lean solution heat exchanger, the steam-rich solution heat exchanger, the steam-cooling water heat exchanger, and the lean amine solution-cooling water heat exchanger are all printed circuit heat exchangers (PCHE).

As an implementation mode, an inlet of a rich amine solution pump is connected to a bottom of the rich amine solution tank, and an outlet of the rich amine solution pump is connected to the lean/rich solution heat exchanger via a rich amine solution regulating valve.

As an implementation mode, a flue gas blower is connected to a gas inlet of the first high-gravity device;

As an implementation mode, a steam blower is connected to the gas outlet of the second high-gravity device, for delivering the mixed gas of CO₂ and steam into the steam-rich solution heat exchanger;

As an implementation mode, an inlet of a condensate pump is connected to a bottom of the CO₂-water separator, to deliver the condensate water to the lean amine solution tank;

As an implementation mode, the lean solution is delivered to the lean solution heat exchanger by a lean solution pump for heat exchange.

The beneficial effects of the present invention are as follows:

(1) According to the high-gravity device of the present invention, the packing upper clamping plate is designed from a horizontal plate to a plate with the certain inclination angle by considering the influence of the gravity of the earth on the solution distribution in the packing, which improves the uniformity of the gas-solution distribution in the upper half of the packing, and reduces the area of ineffective gas-solution contact; an annular bulge is added on the packing lower clamping plate of the packing, which promotes the solution gathered at the bottom of the packing due to the influence of gravity to rise again, improves the solution utilization rate, and enables the gas-solution to contact fully.

(2) According to the energy-optimized high-gravity decarbonization system of the present invention, a falling-film reboiler with higher heat exchange efficiency is adopted instead of the kettle reboiler, which reduces heating power consumption and simultaneously reduces equipment floor space; MCM-41 molecular sieve regeneration solid catalyst is also added inside the falling-film reboiler, which promotes amine solution resolution and further reduces heating power consumption; and, a second high-gravity device is added as a resolving device in the system, a heat released by steam condensation is recovered by the steam-rich amine solution heat exchanger connected to the gas outlet of the second high-gravity device, which further reduces power consumption of the whole energy-optimized high-gravity decarbonization system.

Additional aspects of the present invention will be set forth in part in the description which follows, and in part will be obvious from the description, or may be learned by practice of the present invention.

### BRIEF DESCRIPTION OF THE DRAWINGS

The accompanying drawings constituting a part of the present invention are used to provide a further understanding of the present invention. The exemplary examples of the present invention and descriptions thereof are used to explain the present invention, and do not constitute an improper limitation of the present invention.

FIG. 1 is a schematic structural diagram of a high-gravity device according to an embodiment of the present invention;

FIG. 2 is a top view of a lower clamp plate of packing of the high-gravity device according to an embodiment of the present invention.

FIG. 3 is a schematic diagram of an energy-optimized high-gravity decarbonization system according to an embodiment of the present invention.

In the figures: 1, spray pipe; 2, packing; 3, external spray pipe; 4, static disc; 5, movable disc; 6, solution outlet; 7, bearing seal; 8, housing; 9, gas inlet; 10, packing lower clamping plate; 11, packing upper clamping plate; 12, gas outlet; 13, annular bulge; 14, flue gas blower; 15, first high-gravity device; 16, rich amine solution tank; 17, rich amine solution regulating valve; 18, rich amine solution pump; 19, lean/rich solution heat exchanger; 20, steam-rich solution heat exchanger; 21, steam-cooling water heat exchanger; 22, lean amine solution-cooling water heat exchanger; 23, tubular falling-film reboiler; 24, gas-solution separator; 25, hydrothermal pump; 26, steam blower; 27, second high-gravity device; 28, lean amine solution tank; 29, CO₂-water separator; 30, condensate pump; 31, lean solution pump.

### DETAILED DESCRIPTION

The present invention will now be further described with reference to the accompanying drawings and examples.

It should be pointed out that the following detailed descriptions are all illustrative and are intended to provide further descriptions of the present invention. Unless otherwise specified, all technical and scientific terms used in the present invention have the same meanings as those usually understood by a person of ordinary skill in the art to which the present invention belongs.

It should be noted that the terms used herein are merely used for describing specific implementations, and are not intended to limit exemplary implementations of the present invention. As used herein, the singular form is also intended to include the plural form unless the context clearly dictates otherwise. In addition, it should further be understood that, terms “comprise” and/or “comprising” used in this specification indicate that there are features, steps, operations, devices, components, and/or combinations thereof.

In the process of gas purification and absorption analysis by high-gravity method, the energy consumption mainly comes from heating and regeneration of rich amine solution. The regeneration process is usually to further heat the rich solution preliminarily heated by the lean/rich heat exchanger by using a kettle reboiler, and the rich solution becomes a hot lean solution after regeneration by the regeneration device, the hot lean solution exchanges heat with the cold rich solution from the absorption device in the lean/rich heat exchanger, and then the lean solution after heat exchange is further cooled and re-delivered to the absorption device as absorption solution.

### <High-gravity Device>

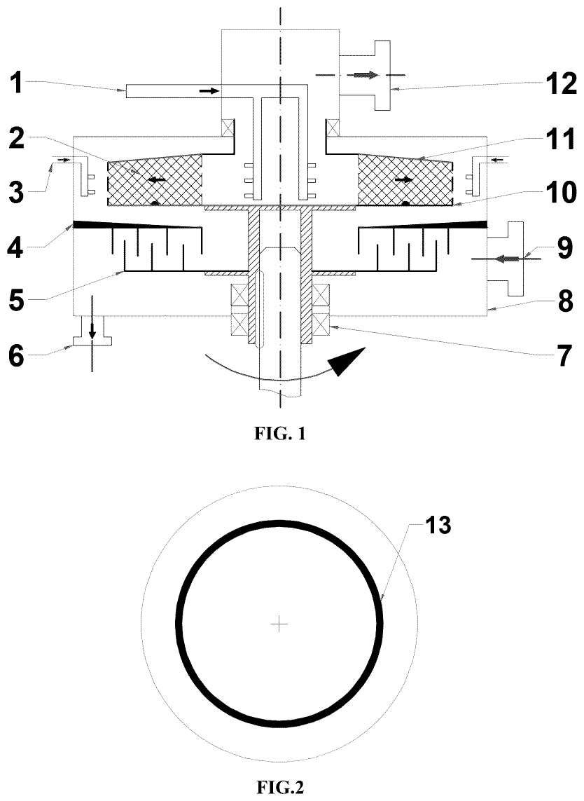

According to FIG. 1, the present embodiment provides a high-gravity device, which comprises: a housing 8, wherein a cavity is formed in the housing 8, and a rotating shaft, a packing 2, a packing lower clamping plate 10 and a packing upper clamping plate 11 are arranged in the cavity; and, a solution inlet, a solution outlet 6, a gas inlet 9 and a gas outlet 12 is further provided on the housing 8.

The packing 2 is arranged between the packing upper clamping plate 11 and the packing lower clamping plate 10, the packing upper clamping plate 11 has a certain inclination angle, and a section of the packing is trapezoidal in shape; an annular bulge 13 is provided on the packing lower clamping plate 10; one end of the rotating shaft is arranged in the cavity, and another end extends out of the housing 8 and is connected with a driving mechanism (such as a motor, etc.); the packing 2 is symmetrically arranged on both sides of the rotating shaft, and spray pipes 1 are arranged on both sides of the rotating shaft and connected with a solution inlet.

In the present embodiment, the spray pipes 1 are symmetrically arranged to maintain dynamic balance, which ensures a high stability of the moving parts when rotating at high speed, and prolongs the service life of the moving parts.

An inner wall of the housing 8 is also symmetrically provided with a static disk 4, the rotating shaft is symmetrically provided with a movable disk 5, and the movable disk 5 is arranged under the static disk 4. The solution inlet is used for introducing solution and sprinkling the solution on the inner side surface of the packing 2 through the spray pipes 1; the solution on the inner wall of the housing 8 flows into an inner ring of the movable disc 5 through an upper surface of the static disc 4 under the action of gravity, then is thrown out from an outer ring of the movable disc 5 under the action of centrifugal force, and then is finally led out through the solution outlet 6.

In one or more embodiments, the upper surface of the static disk 4 is inclined in a funnel shape, which promotes the flow of the solution under the influence of gravity.

The gas inlet 9 is used for introducing gas to be purified, the gas to be purified flows from the outer ring to the inner ring of the movable disk 5 under the action of gas pressure, and then flows from the outer side of the packing 2 to the center of the packing. In the flow process, the gas to be purified contacts with amine solution in countercurrent and transfers mass and heat. The purified gas (flue gas) leaves the cavity from the center of the rotating shaft and is finally led out from the gas outlet 12.

In the present embodiment, a portion of the rotating shaft extending out of the housing 8 is connected to the housing 8 through the bearing seal 7.

The solution enters from the solution inlet and is sprinkled on the inner circumferential surface of the packing 2 through the spray pipes 1, and flows to the outer edge of the packing under the action of centrifugal force. In this process, the solution is dispersed, cut and broken by the huge shear-force of the packing, forming solution filaments, solution films and droplets that cannot be formed under conventional conditions. The surface area of the solution is extremely large and constantly updated. The tortuous flow paths in the packing intensify the update of the solution surface, thus forming excellent mass transfer and reaction conditions inside the rotating shaft.

In the present embodiment, by considering the influence of the gravity of the earth on the solution distribution in the packing, the packing upper clamping plate 11 is provided with a certain inclination angle, which improves the uniformity of the gas-solution distribution in the upper half of the packing and reduces the area of ineffective gas-solution contact. The annular bulge 13 is added on the packing lower clamping plate 10, as shown in FIG. 2, to promote the solution collected at the bottom of the packing due to the influence of gravity to rise again, improve the utilization rate of the solution, and make the gas and solution fully contact. Then, the solution is thrown to the inner wall of the housing by the rotating shaft, then flows into the inner ring of the movable disk 5 through the upper surface of the static disk 4 under the action of gravity, then is thrown out from the outer ring of the movable disk 5 under the action of centrifugal force, and then is finally led out from the solution outlet 6. The gas is introduced into the cavity of the high-gravity device from the gas inlet 9, then flows from the outer ring to the inner ring of the movable disk 5 under the action of gas pressure, and then flows from the outer side of the packing 2 to the center of the packing. In the process of flowing, the gas contacts with the solution in countercurrent and transfers mass and heat. The purified gas leaves the cavity from the center of the rotating shaft and is finally led out from the gas outlet 12.

In one or more embodiments, a length of a short base of the trapezoid of the packing, as the axial height of the packing, is obtained by deducing and calculating an average residence time of the solution; and
the average residence time of the solution can be obtained by deriving the solution holdup rate, as shown in Equation (2).

When the packing is foam nickel, a correlation equation for estimating solution holdup rate ε_{L} in high porosity packing is shown in Equation (1).

$${ε}_{L} = 0.039 {( \frac{r {ω}^{2}}{{g}_{0}} )}^{- 0.5} {( \frac{{V}_{L}}{{V}_{0}} )}^{0.6} {( \frac{{υ}_{L}}{{υ}_{0}} )}^{0.22} \qquad ( 1 )$$

$$\overline{t} = \frac{{r}_{2} - {r}_{1}}{( {Q}_{L} / 2 π {r}_{a v g} h )} {ε}_{L} \qquad ( 2 )$$

wherein, g₀ is set as 100 m/s², V₀ is set as 0.01 m/s, v₀ is set as 10⁻⁶ m²/s, V_{L} is the velocity of the solution passing through the packing, V_{L} is the kinematic viscosity of the solution, Q_{L} is the volumetric flow rate of the solution, r_{avg} is the average of the inner and outer radius of the packing, ω is the angular velocity of the rotating shaft, r is the radius of the packing, wherein r₁ and r₂ is an inner radius and an outer radius of the packing respectively, and h is the axial height of the packing.

The following is an example of flue gas decarbonization:

Flue gas decarbonization is carried out by using a mixed solution of ethanolamine (MEA) and potassium carbonate (K₂CO₃), the lean amine solution enters the cavity through the solution inlet 1 and is sprayed onto the inner circumferential surface of the packing 2 through the spray pipes, and then flows to the outer edge of the packing under the action of centrifugal force. In this process, the solution is dispersed, cut and broken by the huge shear force of the packing, forming solution filaments, solution films and droplets that cannot be formed under conventional conditions, thus the surface area of the solution is extremely large and constantly updated. The tortuous flow paths in the packing intensify the update of the solution surface, thus creating excellent mass transfer and reaction conditions inside the cavity. Further, considering the influence of the gravity of the earth on the solution distribution in the packing, the packing upper clamping plate 11 is provided with the certain inclination angle, that improves the uniformity of the gas-solution distribution in the upper half part of the packing and reduces the area of ineffective gas-solution contact. The annular bulge 13 added on the packing lower clamping plate 10 may promote the solution collected at the bottom of the packing due to the influence of gravity to rise again, which improves the utilization rate of the solution, and makes the gas and solution fully contact. Then, the solution is thrown by the rotating shaft to the inner wall of the housing and led out from the solution outlet 6 under the action of gravity. Flue gas is introduced into the cavity through the gas inlet 9 and enters the packing 2 from the outer edge of the packing under the action of gas pressure. The purified flue gas leaves the cavity from the center of the rotating shaft and is finally led out from the gas outlet 12.

In the high-gravity device of the present invention, the packing upper clamping plate is designed from a horizontal plate to a plate with certain inclination angle by considering the influence of the gravity of the earth on the solution distribution in the packing, which improves the uniformity of the gas-solution distribution in the upper half of the packing, and reduces the area of ineffective gas-solution contact; an annular bulge is added on the packing lower clamping plate of the packing, which promotes the solution gathered at the bottom of the packing due to the influence of gravity to rise again, improves the solution utilization rate, and enables the gas-solution to contact fully.

### <Energy-Optimized High-Gravity Decarbonization System>

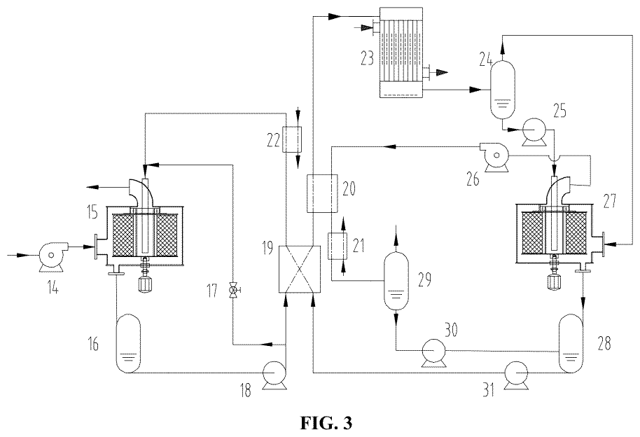

According to FIG. 3, the present embodiment provides an energy-optimized high-gravity decarbonization system, comprising: a flue gas blower 14, a first high-gravity device 15, a rich amine solution tank 16, a rich amine solution regulating valve 17, a rich amine solution pump 18, a lean/rich amine solution heat exchanger 19, a steam-rich solution heat exchanger 20, a steam-cooling water heat exchanger 21, a lean amine solution-cooling water heat exchanger 22, a tubular falling-film reboiler 23, a gas-solution separator 24, a hot solution pump 25, a steam blower 26, a second high-gravity device 27, a lean amine solution tank 28, a CO₂-water separator 29, a condensate pump 30 and a lean solution pump 31.

Wherein, the first high-gravity device 15 is used as a high-gravity absorber and the second high-gravity device 27 is used as a high-gravity resolver, and both the first high-gravity device and the second high-gravity device are identical to the high-gravity device described in the first embodiment.

Specifically, the flue gas blower 14 is connected to the gas inlet of the first high-gravity device 15, and the solution outlet of the first high-gravity device 15 is connected to the uppermost end of the outer wall of the rich amine solution tank 16, so that the rich amine solution flows along the tank wall to reduce foaming of the amine solution.

The bottom of the rich amine solution tank 16 is connected to the inlet of the rich amine solution pump 18, and the outlet of the rich amine solution pump 18 is connected to the rich/poor solution heat exchanger 19 via the rich amine solution regulating valve 17. By opening the rich amine solution regulating valve 17, the rich amine solution can be introduced into the solution inlet of the absorption device to further absorb CO₂, so as to increase the actual CO₂ load of the rich amine solution. On the one hand, the solution flow rate of the absorption device is increased, and the gas purification rate is improved; on the other hand, more CO₂ can be resolved under the unit energy consumption of rich amine solution with high CO₂ load, so that the resolution efficiency of the resolution device is improved, and the system energy consumption is reduced.

The rich solution outlet of the lean/rich solution heat exchanger 19 is connected to the rich solution inlet of the steam-rich solution heat exchanger 20, and the rich solution outlet of the steam-rich solution heat exchanger 20 is connected to the solution inlet of the tubular falling-film reboiler 23.

wherein, the advantages of the falling-film reboiler are: the solution flows in film form in the reboiler, and the heat transfer coefficient is high; the residence time is short, and it is not easy to cause material deterioration; it is suitable for foaming materials, and a whole regeneration process of material solution does not form too much impact, avoiding the formation of foam; it can evaporate materials with higher concentration and higher viscosity; it can use low temperature difference evaporation; the solution retention is small, and the falling film reboiler can operate rapidly according to the changes of energy supply, feed volume, concentration, etc.

MCM-41 molecular sieve regeneration solid catalyst is added to the path of solution flow in the tubular falling-film reboiler 23 to regenerate solid catalyst to promote amine solution resolution.

A material outlet of the tubular falling-film reboiler 23 is connected to a gas-solution separator 24, the solution in the gas-solution separator 24 is sent to a solution inlet of the second high-gravity device 27 by a thermal solution pump 25, and the steam in the gas-solution separator 24 is introduced into a gas inlet of the second high-gravity device 27.

In the second high-gravity device 27, steam stripping hot amine solution is carried out, the large concentration difference between the steam and the hot amine solution makes CO₂ transfer from a liquid-phase to a gas-phase quickly, and at the same time, part of steam liquefaction provides heat for amine solution resolution reaction, and the advantage of high-gravity machine in “three-transfer and one-reaction” accelerates the regeneration of the amine solution. The steam blower 26 is connected to the gas outlet of the second high-gravity device 27, and sends the mixed gas of CO₂ and steam into the steam-rich solution heat exchanger 20. The mixed gas after heat exchange is introduced into the steam-cooling water heat exchanger 21 to further reduce the temperature, condense the steam, and purify the CO₂.

The inlet of the condensate pump 30 is connected to the bottom of the CO₂-water separator 29, and the condensate water is delivered to the lean amine solution tank 28, the lean amine solution tank 28 is connected to the solution outlet of the second high-gravity device 27, and the collected lean solution is delivered to the lean/rich solution heat exchanger 19 by the lean solution pump 31 for heat exchange, and is further cooled by the lean amine solution-cooling water heat exchanger 22 and then is delivered to the first high-gravity device 15 as the absorption solution.

In one or more embodiments, the lean solution heat exchanger 19, the steam-rich solution heat exchanger 20, the steam-cooling water heat exchanger 21, and the lean amine solution-cooling water heat exchanger 22 all employ printed circuit heat exchangers (PCHE). The PCHE is compact in design, typically 4-6 times smaller in volume and lighter in weight than conventional shell and tube heat exchangers at the same heat load and pressure drop.

It should be noted here that in other embodiments, a person skilled in the art can specifically select specific models and structures of the lean solution heat exchanger, the steam-rich solution heat exchanger, the steam-cooling water heat exchanger and the lean amine solution-cooling water heat exchanger according to actual requirements, and details thereof are not described herein.

The foregoing descriptions are merely preferred embodiments of the present invention but are not intended to limit the present invention. A person skilled in art may make various alterations and variations to the present invention. Any modification, equivalent replacement, or improvement made within the spirit and principle of the present invention shall fall within the protection scope of the present invention.

1. A high-gravity device, comprising:
a housing, having a cavity therein, wherein a rotating shaft, a packing, a packing lower clamping plate and a packing upper clamping plate are provided in the cavity; and, a solution inlet, a solution outlet, a gas inlet and a gas outlet are provided on the housing; wherein
the packing upper clamping plate is provided with a certain inclination angle, the packing arranged between the packing upper clamping plate and the packing lower clamping plate is trapezoidal in section; and, an annular bulge is arranged on the packing lower clamping plate;
one end of the rotating shaft is arranged in the cavity, and another end of the rotating shaft extends out of the housing and is connected with a driving mechanism; and
the packing is symmetrically arranged on both sides of the rotating shaft, spray pipes are provided on the both sides of the rotating shaft, and the spray pipes are connected with the solution inlet.

2. The high-gravity device according to claim 1, wherein a static disk is symmetrically arranged on an inner wall of the housing, a movable disk is symmetrically arranged on the rotating shaft, the movable disk is arranged under the static disk, solution on the inner wall of the housing flows into an inner ring of the movable disk through an upper surface of the static disk under an action of gravity, then is thrown out from an outer ring of the movable disk under an action of centrifugal force, and then is finally led out from the solution outlet.

3. The high-gravity device according to claim 1, wherein an axial height of the packing is obtained by calculating an average residence time of the solution; wherein the axial height of the packing is the length of a short base of the trapezoid of the packing in section.

4. The high-gravity device according to claim 3, wherein the average residence time of the solution is derived from a solution holdup rate.

5. The high-gravity device according to claim 1, wherein the gas inlet is used for introducing gas to be purified, the gas to be purified enters the packing from an outer edge of the rotating shaft under an action of gas pressure, and contacts with the solution in countercurrent and transfers mass and heat, then a purified gas leaves the rotating shaft from a center of the rotating shaft and is finally led out from the gas outlet.

6. The high-gravity device according to claim 1, wherein a portion of the rotating shaft extending out of the housing is connected to the housing by a bearing seal.

7. An energy-optimized high-gravity decarbonization system, comprising:
a first high-gravity device, a rich amine solution tank, a lean/rich solution heat exchanger, a steam-rich solution heat exchanger, a steam-cooling water heat exchanger, a lean amine solution-cooling water heat exchanger, a tubular falling-film reboiler, a gas-solution separator, a second high-gravity device, a lean amine solution tank, and a CO₂-water separator; wherein, the first high-gravity device and the second high-gravity device both are the high-gravity device according to claim 1; wherein
the first high-gravity device is connected to an uppermost end of an outer wall of the rich amine solution tank;
a rich amine solution is outputted from a bottom of the rich amine solution tank and is delivered to the lean/rich solution heat exchanger;
a rich solution outlet of the lean/rich solution heat exchanger is connected to a rich solution inlet of the steam-rich solution heat exchanger, and a rich solution outlet of the steam-rich solution heat exchanger is connected to a solution inlet of the tubular falling-film reboiler;
a molecular sieve regeneration solid catalyst is added on a path through which a solution in the tubular falling-film reboiler flows; a material outlet of the tubular falling-film reboiler is connected to the gas-solution separator, a solution in the gas-solution separator is delivered to a solution inlet of the second high-gravity device, and a steam in the gas-solution separator is introduced into a gas inlet of the second high-gravity device;
a mixed gas of CO₂ and steam is delivered from a gas outlet of the second high-gravity device into the steam-rich solution heat exchanger, and then is led into the steam-cooling water heat exchanger after heat exchange; and
a condensed water output from a bottom of the CO₂-water separator is delivered to the lean amine solution tank, a solution outlet of the second high-gravity device is connected to the lean amine solution tank, a lean solution collected in the lean amine solution tank from the second high-gravity device is delivered to the lean/rich solution heat exchanger for heat exchange, further is cooled via the lean amine solution-cooling water heat exchanger, and finally is delivered to the first high-gravity device as an absorption solution.

8. The energy-optimized high-gravity decarbonization system according to claim 7, wherein the lean solution heat exchanger, the steam-rich solution heat exchanger, the steam-cooling water heat exchanger, and the lean amine solution-cooling water heat exchanger are all printed circuit heat exchangers (PCHE).

9. The energy-optimized high-gravity decarbonization system according to claim 7, wherein an inlet of a rich amine solution pump is connected to a bottom of the rich amine solution tank and an outlet of the rich amine solution pump is connected to the lean/rich solution heat exchanger via a rich amine solution regulating valve.

10. The energy-optimized high-gravity decarbonization system according to claim 7, wherein a flue gas blower is connected to a gas inlet of the first high-gravity device.

11. The energy-optimized high-gravity decarbonization system according to claim 7, wherein a steam blower is connected to the gas outlet of the second high-gravity device, for delivering the mixed gas of CO₂ and steam into the steam-rich solution heat exchanger.

12. The energy-optimized high-gravity decarbonization system according to claim 7, wherein an inlet of a condensate pump is connected to a bottom of the CO₂-water separator, to deliver the condensate water to the lean amine solution tank.

13. The energy-optimized high-gravity decarbonization system according to claim 7, wherein the lean solution is delivered to the lean solution heat exchanger by a lean solution pump for heat exchange.
